(19) United States
(12) Patent Application Publication
(10) Pub. No.: US 2025/0101608 A1
(43) Pub. Date: Mar. 27, 2025

(54) BI-FUNCTIONAL WEAVE BODY

(71) Applicant: HYAXIOM, INC., East Hartford, CT (US)

(72) Inventor: Trent Simonetti, Boston, MA (US)

(21) Appl. No.: 18/373,668

(22) Filed: Sep. 27, 2023

(51) Int. Cl. C25B 9/23; B01D 67/00; C23C 4/129; C25B 1/04; C25B 13/05; C25D 7/06

(52) U.S. Cl. CPC C25B 9/23; B01D 67/0069; C23C 4/129; C25B 1/04; C25B 13/05; C25D 7/065; C23C 2222/00

(57) ABSTRACT

An illustrative example embodiment of an apparatus and method includes providing a weave body downstream of an electrolyzer, purifying hydrogen by demisting a hydrogen stream exiting the electrolyzer via flow through the weave body; and de-oxidizing the hydrogen stream during flow through the weave body.

BACKGROUND

An electrolyzer uses electricity to split water into hydrogen and oxygen. One example of an electrolyzer is a Polymer Electrolyte Membrane (PEM) electrolyzer, which typically includes a membrane electrode assembly (MEA) having an anode on one side and a cathode on the other. Current fuel cell vehicle standards (e.g., ISO14687) have strict requirements for hydrogen purity, particularly with respect to moisture and oxygen. Additionally, current electrolyzer codes and standards (e.g., KGS AH271) also require the use of a catalytic deoxidizer. To meet these requirements, the current industry standard for deoxidation is a platinum (Pt) or palladium (Pd) material on an alumina support, which is used to catalyze the recombination of oxygen gas with hydrogen gas. This adds a pressure vessel to an associated hydrogen processing system, as well as many other additional expensive components.

### SUMMARY

An illustrative example embodiment of a method includes: providing a weave body downstream of an electrolyzer; purifying hydrogen by demisting a hydrogen stream exiting the electrolyzer via flow through the weave body; and de-oxidizing the hydrogen stream during flow through the weave body.

In an embodiment having one or more features of the method of the previous paragraph, the weave body is comprised of a titanium material.

In an embodiment having one or more features of the method of the previous paragraph, the method includes applying platinum to the weave body.

In an embodiment having one or more features of the method of the previous paragraph, the weave body is comprised of weave members having a greater length than a thickness, and including applying platinum particles to the weave members.

In an embodiment having one or more features of the method of the previous paragraph, the electrolyzer comprises a Polymer Electrolyte Membrane Water Electrolyzer (PEMWE), alkaline electrolyzer, or solid oxide electrolyzer.

An illustrative example embodiment of a method of making a component includes: forming a weave body from a titanium material; and applying platinum to the weave body.

In an embodiment having one or more features of the method of the previous paragraph, the step of applying platinum occurs subsequent to the step of weaving the weave body from titanium.

In an embodiment having one or more features of the method of the previous paragraph, the step of applying platinum forms a functionalized titanium substrate surface capable of catalyzing the deoxygenation reaction, and wherein the step of applying platinum to the weave body includes using electroplating, chemical vapor deposition, or flame spraying to apply platinum on the titanium substrate surface.

In an embodiment having one or more features of the method of the previous paragraph, the method includes forming the mesh body from titanium weave members each having a greater length than thickness, and applying platinum particles to the weave members.

In an embodiment having one or more features of the method of the previous paragraph, the method includes including forming the weave body to have an input side associated with a hydrogen output from an electrolyzer.

An illustrative example embodiment of a component includes: a weave body; a hydrogen purifying material applied to the weave body; and a de-oxidation material applied to the weave body.

In an embodiment having one or more features of the component of the previous paragraph, the weave body includes an input side associated with a hydrogen stream exiting an electrolyzer.

In an embodiment having one or more features of the component of the previous paragraph, the electrolyzer comprises a Polymer Electrolyte Membrane Water Electrolyzer (PEMWE), alkaline electrolyzer, or solid oxide electrolyzer.

In an embodiment having one or more features of the component of the previous paragraph, the hydrogen purifying material comprises a demister.

In an embodiment having one or more features of the component of the previous paragraph, the de-oxidation material comprises platinum.

In an embodiment having one or more features of the component of the previous paragraph, the weave body is comprised of a titanium material.

Various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a selected portion of an example electrolyzer assembly.

FIG. 2A is a schematic prior art view of an example system for purifying hydrogen.

FIG. 2B is a is a schematic view of an example system for purifying hydrogen according to the disclosure.

FIG. 3A schematically illustrates one example embodiment of weave members in an initial state with platinum particles deposited onto the weave members.

FIG. 3B schematically illustrates one example embodiment of a woven body made from the material of FIG. 3A.

### DETAILED DESCRIPTION

Embodiments of this disclosure include a weave body that is used for demisting a hydrogen stream exiting an electrolyzer prior to entry into a desiccant bed. In one example, there is an integration of materials onto a titanium weave body for purifying and deoxidizing purposes. This provides for a cost reduction due to hydrogen processing system simplification. Additionally, this results in decreased material cost and sub-system size.

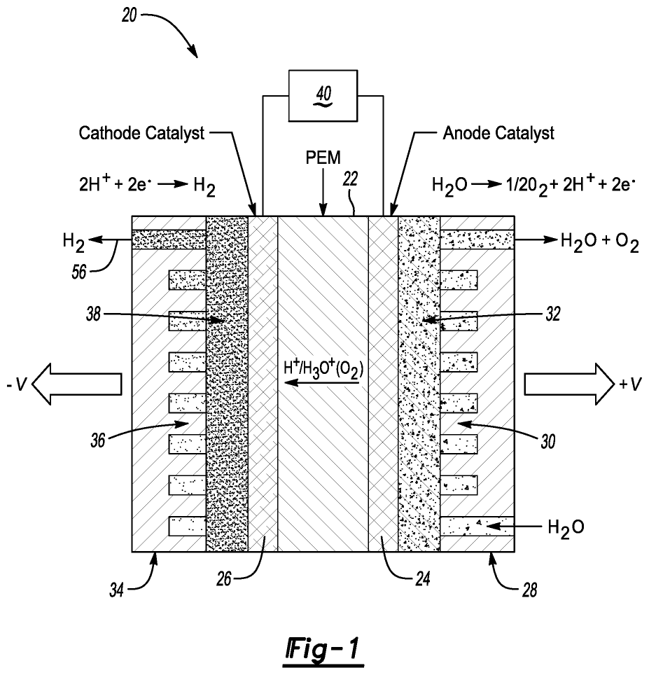

FIG. 1 schematically illustrates an electrolyzer assembly 20, such as a Polymer Electrolyte Membrane Water Electrolyzer (PEMWE), for example. The operation of the electrolyzer assembly 20 is known and the PEMWE is just one example of an electrolyzer, other types could also be used.

In the example of FIG. 1, a Polymer Electrolyte Membrane (PEM) 22 is situated between an anode catalyst layer 24 and a cathode catalyst layer 26. An anode portion 28 includes an anode flowfield component 30 and an anode transport layer 32. A cathode portion 34 includes a cathode flowfield component 36 and a cathode transport layer 38. FIG. 1 shows a diffusion of H₂O and O₂ from the anode 28 to a cathode 34. A power source 40 supplies current to facilitate an electrolysis reaction for producing hydrogen and oxygen, for example.

Current fuel cell vehicle standards and hydrogen liquification have strict requirements for hydrogen purity, especially with regard to moisture and oxygen. Electrolysis of hydrogen from water may be subject to crossover of oxygen gas through dissolution within electro-osmotic drag water, or incomplete electrolyte saturation when there is flowing alkaline electrolyte during cycling conditions. Additionally, there are also requirements for deoxidization when using electrolyzers. These requirements traditionally involve the incorporation of additional system components which increases cost.

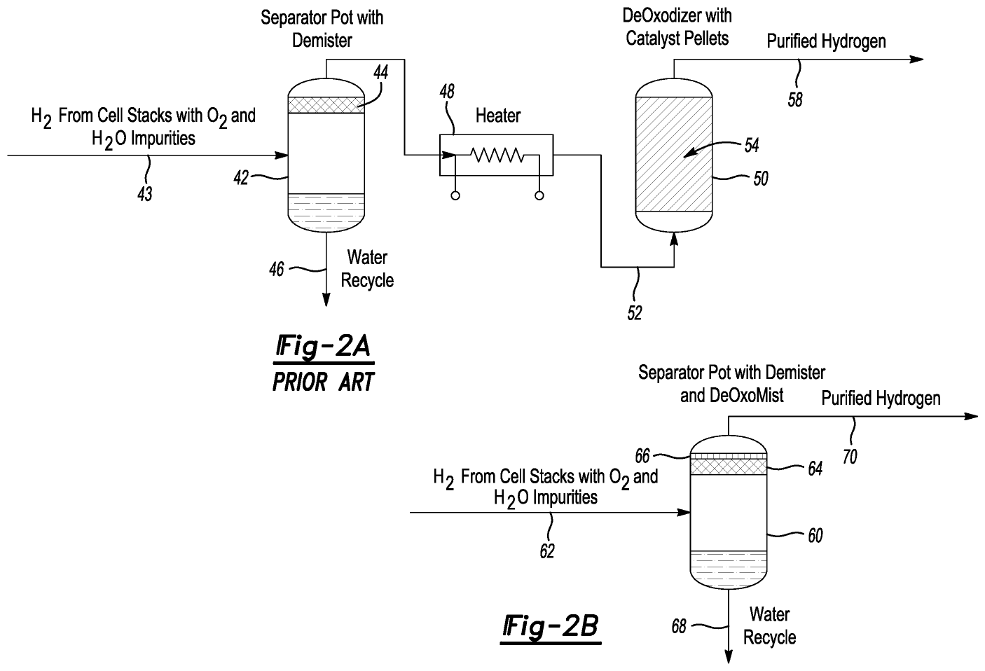

FIG. 2A shows a traditional example system for purifying hydrogen. H₂ from cell-stacks with O₂ and H₂O impurities are directed into a separator pot 42 as indicated at 43. The separator pot 42 includes a demister 44. Water is recycled out of the separator pot 42 as indicated at 46, and the remaining hydrogen with impurities exits the separator pot 42 and enters a heater 48. The heated hydrogen with impurities is directed into a deoxidizer 50 as indicated at 52. The deoxidizer 50 has catalyst pellets 54 that react with the hydrogen and oxygen to remove the oxygen impurities and provide purified hydrogen as indicated at 58.

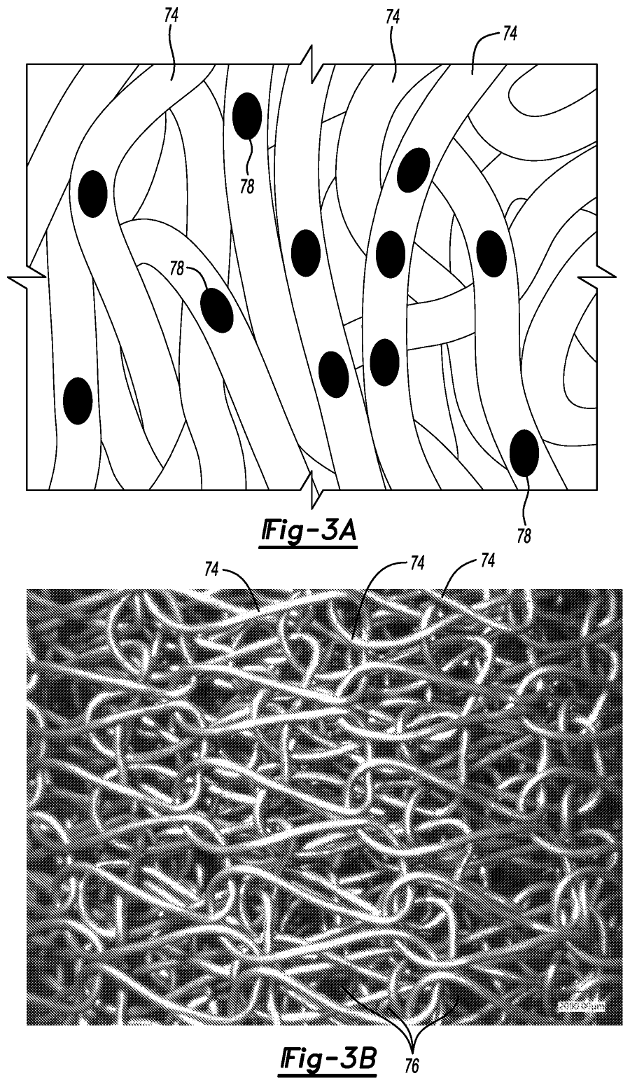

FIG. 2B shows an example system that purifies hydrogen according to the subject disclosure. In this example, H₂ from cell-stacks with O₂ and H₂O impurities are directed into a separator pot 60 as indicated at 62. The separator pot 60 includes a demister 64 and a catalyzed weave body as demonstrated in FIG. 3, the combination of which is referred to as DeOxoMist. Water is recycled out of the separator pot 60 as indicated at 68 and purified hydrogen exits the pot 60 as indicated at 70.

The subject disclosure provides a solution where materials are integrated onto a high surface area titanium weave that is used for simultaneous purification of water droplets and oxygen from hydrogen.

FIGS. 3A-3B show one disclosed example of a weave body 72 that comprises a material that is relatively anisotropic, i.e. has a physical property that has a different value when measured in different directions. The weave body 72 includes a plurality of weave members 74 that each have a greater length than a thickness. In one example, one side of the weave body 72 comprises an input side that is associated with a hydrogen stream 56 (FIG. 1) exiting the electrolyzer assembly 20. In one example, the weave body 72 has a plurality of pores or openings 76. Areas between the openings 76 provide a surface area through which fluid cannot pass. In one example, the weave body 72 has a total surface area for platinum application that is similar to pelletized catalyst applications.

In one example, the weave body 72 is comprised of a titanium or other similar type material. As shown in FIG. 3A, the weave members 74 comprises elongated strands each having greater length than thickness. Platinum particles 78 are then deposited onto the weave members 74. FIG. 3B shows the weave body 72 that is woven from the material shown in FIG. 3A. The final part geometry will be that of a porous pad similar in geometry to existing demisting media 44/64.

In one example, the weave is manufactured from titanium wire. Platinum is applied to titanium, for example, by electroplating, chemical vapor deposition, or flame based processes. The step of applying platinum to the weave body 50 forms a functionalized titanium substrate surface capable of catalyzing the deoxygenation reaction. In one example, the step of applying platinum to the weave body 50 includes electroplating, chemical vapor deposition, or flame spraying platinum on the substrate surface.

In one example the platinum is applied in a low percentage. Various surface areas of platinum are defined as a function of an extent of purification required. In one example the platinum is applied at approximately 1 weight %; however, this percentage can be varied. The aforementioned application methods provide high surface area of well distributed particles of platinum.

The weave body 50 with integrated first and second materials 66, 68, provides for a bi-functional weave body. The bi-functional weave body 50 is used for demisting the hydrogen stream to increase purity of the hydrogen while also serving as a deoxidizer. In one example, the platinum material provides for a reaction to remove oxygen from the hydrogen stream 56 as it flows through the weave body 50. The equations that describe the reaction are known to one of skill in the art.

The subject disclosure provides for a titanium weave body with a high surface area that is used for moisture droplet adsorption to ease moisture loading on downstream desiccant bed, and improve downstream dryer effectiveness. In one example, a design of the catalyst bed is matched to achieve the reaction. Platinization through various aforementioned application methods is used to form the functionalized titanium substrate surface capable of catalyzing the deoxygenation reaction. This high surface area platinum is catalytically active to complete the deoxidation reaction required for oxygen purity. This simplifies the hydrogen processing system resulting in a cost reduction. Additionally, there are decreased material costs and decreased sub-system size.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method comprising;
providing a weave body downstream of an electrolyzer;
purifying hydrogen by demisting a hydrogen stream exiting the electrolyzer via flow through the weave body; and
de-oxidizing the hydrogen stream during flow through the weave body.

2. The method according to claim 1, wherein the weave body is comprised of a titanium material.

3. The method according to claim 2, including applying platinum to the weave body.

4. The method according to claim 2, wherein the weave body is comprised of weave members having a greater length than a thickness, and including applying platinum particles to the weave members.

5. The method according to claim 1, wherein the electrolyzer comprises a Polymer Electrolyte Membrane Water Electrolyzer (PEMWE), alkaline electrolyzer, or solid oxide electrolyzer.

6. A method of making a component comprising:
forming a weave body from a titanium material; and
applying platinum to the weave body.

7. The method according to claim 6, wherein the step of applying platinum occurs subsequent to the step of weaving the weave body from titanium.

8. The method according to claim 6, wherein the step of applying platinum forms a functionalized titanium substrate surface capable of catalyzing the deoxygenation reaction, and wherein the step of applying platinum to the weave body includes using electroplating, chemical vapor deposition, or flame spraying to apply platinum on the titanium substrate surface.

9. The method according to claim 6, including forming the mesh body from titanium weave members each having a greater length than thickness, and applying platinum particles to the weave members.

10. The method according to claim 6, including forming the weave body to have an input side associated with a hydrogen output from an electrolyzer.

11. A component comprising:
a weave body;
a hydrogen purifying material applied to the weave body; and
a de-oxidation material applied to the weave body.

12. The component according to claim 11, wherein the weave body includes an input side associated with a hydrogen stream exiting an electrolyzer.

13. The component according to claim 12, wherein the electrolyzer comprises a Polymer Electrolyte Membrane Water Electrolyzer (PEMWE), alkaline electrolyzer, or solid oxide electrolyzer.

14. The component according to claim 12, wherein the hydrogen purifying material comprises a demister.

15. The component according to claim 12, wherein the de-oxidation material comprises platinum.

16. The component according to claim 12, wherein the weave body is comprised of a titanium material.
